(19) United States
(12) Patent Application Publication
(10) Pub. No.: US 2021/0206194 A1
(43) Pub. Date: Jul. 8, 2021

(54) Hand Peel Pencil

(71) Applicant: Todd Zhou, Potomac, MD (US)

(72) Inventor: Todd Zhou, Potomac, MD (US)

(21) Appl. No.: 17/206,517

(22) Filed: Mar. 19, 2021

(51) Int. Cl. B43K 19/14; B43K 23/10; B43K 19/16

(52) U.S. Cl. CPC B43K 19/14; B43K 19/16; B43K 23/10

(57) ABSTRACT

This Hand Peel Pencil does not need any knife to cut during using. When the writing head is used out, to acquire more writing head people can just use their fingers getting a short cone tube off from the Hand Peel Pencil.

In this way people can save time from finding a suitable knife and cutting their pencil from time to time during writing. Also using Hand Peel Pencil can protect environment from the garbage of cutting of pencil.

### SPECIFICATION

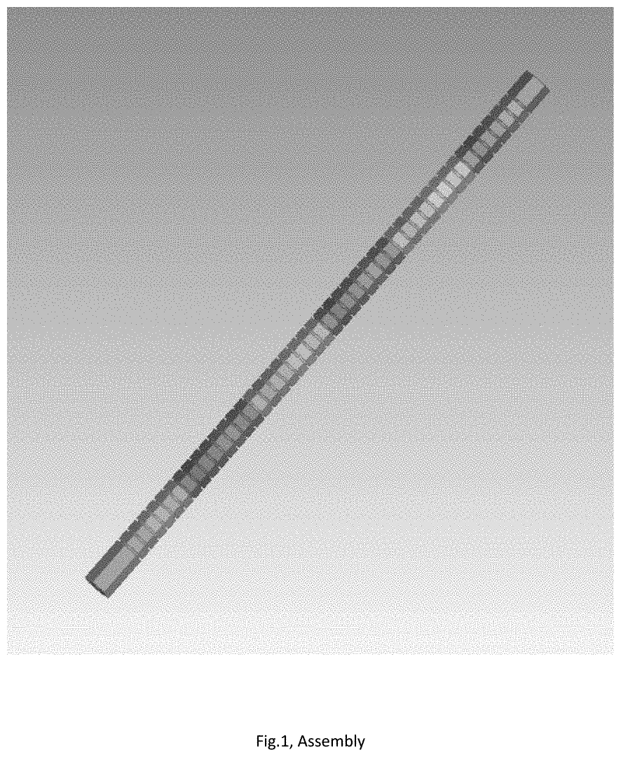

This Hand Peel Pencil, referring FIG. 1, Assembly, is a pencil that does not need any kind of knife to cut when its writing head is worn out. Instead, to get the head out more people can just use their fingers to peel with ease.

### BRIEF DESCRIPTION OF THE DRAWINGS

1) FIG. 1, Assembly: This is an axonometric chart of the Hand Peel Pencil showing its overall exterior.

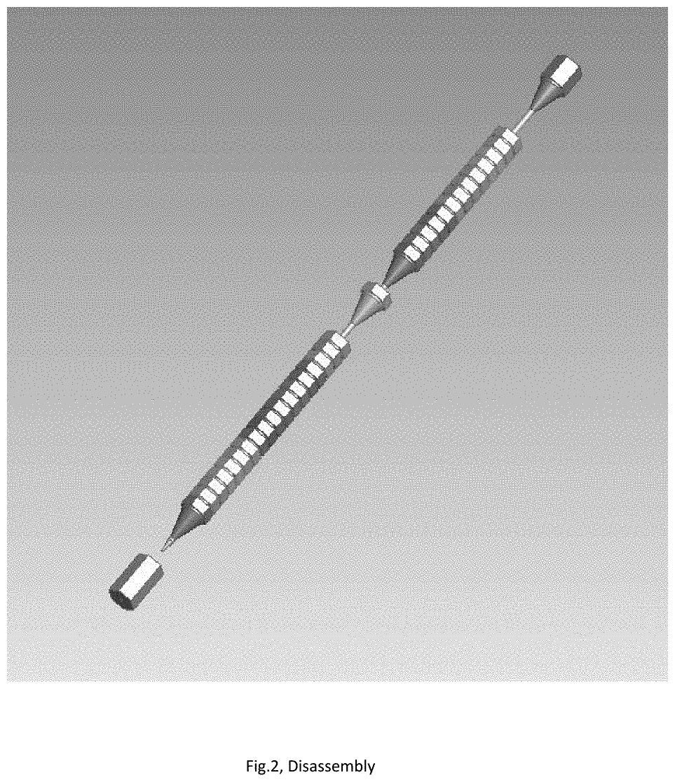

2) FIG. 2, Disassembly: This is also an axonometric chart of the pencil with some parts moved so as to show the internal structure.

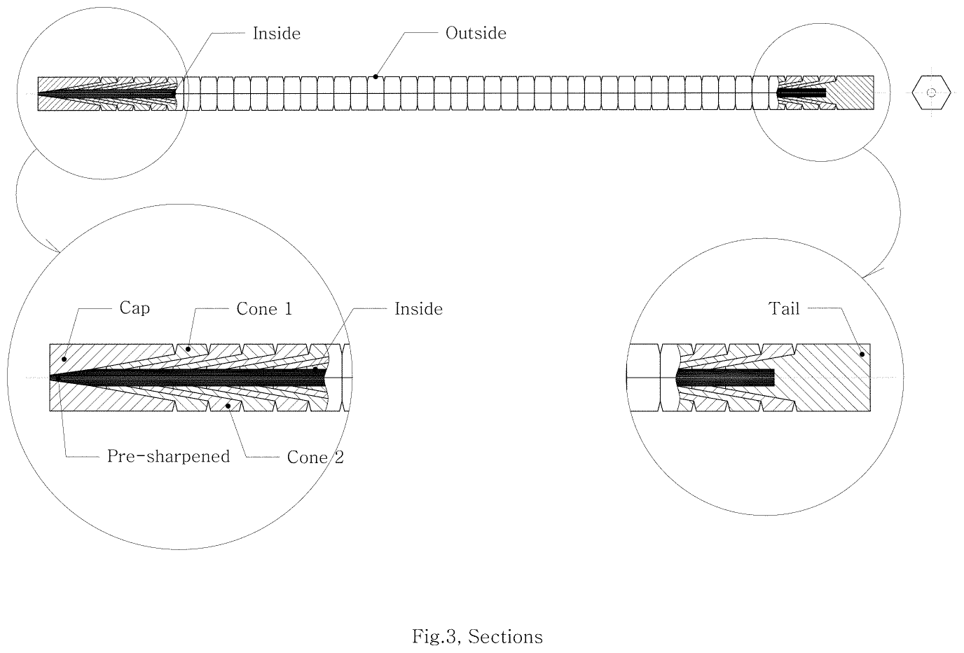

3) FIG. 3, Sections: This is 2D drawing of the pencil with some sections showing the profile, structure and parts' names.

### COMPOSITION

The Hand Peel Pencil is consisted of two parts, like that of an ordinary pencil, inside—writing stick, and outside—wood or some kind of plastic, referring FIG. 2, Disassembly and FIG. 3, Sections. The difference between this Hand Peel Pencil and an ordinary one is on the outside. The outside of the Hand Peel Pencil is comprised of a cluster of cone tubes plus two ends, which are connected together with middle agglutinant glue partly on all cone tubes and ends.

One more different thing is that one end of the writing stick of the Hand Peel Pencil is pre-sharpened so that writing is easy from beginning, referring FIG. 3, Sections.

### USING OF THE HAND PEEL PENCIL

To start the using of the pencil, lay it on a table and put a finger nail into the first groove between the Cap and the Cone 1, then press slightly down a little till the Cap getting off the pencil, referring FIG. 3, Sections. Also, the cap can be twisted away. Then a pre-sharpened writing end comes out.

When the writing end is used away, just get off the next cone tube in the same way of getting off the Cap. In this way the pencil can be used till the other end, Tail.

### ADVANTAGES OF THE HAND PEEL PENCIL

1) No need to prepare a pencil knife.

2) Clean, without contaminating environment by the garbage from the cutting of an ordinary pencil.

3) Save time from finding knife and cutting pencil.

4) Reliable, without any mechanism that may cause broken any time.

1. A cluster of cone tubes is used for the Hand Peel Pencil.

2. Writing stick, i.e. inside of a pencil, is pre-sharpened.
